(19) United States
(12) Patent Application Publication
(10) Pub. No.: US 2014/0065588 A1
(43) Pub. Date: Mar. 6, 2014

(54) Toothbrush Training System

(71) Applicant: IDEAS THAT WORK, LLC, Berkeley Lake, GA (US)

(72) Inventors: Dov Jacobson, Berkeley Lake, GA (US); Jesse Martin Jacobson, Atlanta, GA (US)

(73) Assignee: IDEAS THAT WORK, LLC, Berkeley Lake, GA (US)

(21) Appl. No.: 13/961,938

(22) Filed: Aug. 8, 2013

Related U.S. Application Data
(60) Provisional application No. 61/696,120, filed on Aug. 31, 2012.

(51) Int. Cl. G09B 19/00; A61C 17/16; A46B 17/08; A46B 9/04

(52) U.S. Cl. CPC G09B 19/0084; A46B 9/04; A61C 17/16; A46B 17/08
USPC 434/263; 15/167.1; 15/22.1

(57) ABSTRACT

A toothbrush training system for children includes an instrumented toothbrush with physics sensors, along with optional feedback elements, interacting with a dynamic audio-visual instructional program providing guidance, assessment and feedback on proper brushing procedures. The system provides instruction on tooth brushing technique in combination with monitoring and corrective feedback based on that technique in the context of an audio-visual game environment. The instructional program uses an animated character to illustrate the desired toothbrush positioning and movement for cleaning specific tooth surfaces. The content and progress of the audio-visual presentation may be dynamically altered based on data received from the toothbrush to adjust the presentation in response to a comparison of the instructional information and the actual tooth brushing movement performed by the user.

### REFERENCE TO RELATED APPLICATION

This application claims priority to U.S. Provisional Patent Application Ser. No. 61/696,120 entitled “Toothbrush Trainer” filed Aug. 31, 2012, which is incorporated by reference.

### TECHNICAL FIELD

The present invention relates to multimedia training systems and, more particularly, to a toothbrush training system for children utilizing a toothbrush with physical sensors, along with optional feedback elements interacting with a dynamic audio-visual instructional program providing guidance, assessment and feedback for proper brushing procedures.

### BACKGROUND

Instructing children to brush their teeth effectively and assessing their performance of the tooth brushing task can be a challenge The usual communication methods that may be effective with adults, such as explicit verbal instruction and logical explanation of the consequences of failing to brush properly, may be less effective with children. Children lack the references and the vocabulary required for verbal explanation of the brushing process. They have not yet developed a clear mental image of the topology of their teeth, and are particularly ignorant of those surfaces they cannot easily see. Nor do children readily understand instructional phrases that employ geometric language such as “the correct angle” or “rotate your brush”. Even terms like “left side” and “right side” strain a young child's capacity for spatial abstraction.

Many children may appear to understand verbal instruction but not really comprehend and are not able to put into practice what they are expected to do. Children also tend to have short attention spans, become distracted, and forget instructions resulting in regression even after the tasks have been initially learned. Monitoring tooth brushing effectiveness can be difficult for even a skilled human instructor. Instructive repetition can be frustrating for the adult trainer and child trainee alike. Worse yet, poorly administered training can cause tooth brushing to become a frustrating, tedious or stressful experience that the child wants to avoid.

Electric toothbrushes have been developed with timers that emit a sound or employ vibrators to provide haptic feedback intended to prompt the user to brush certain tooth sections for desired time intervals. These time-keeping systems are ineffective training devices, however, because they fail to provide guidance on how the child should properly hold and move the toothbrush to implement the desired brushing technique. Nor do they provide dynamic feedback based on the user's actual brushing motion compared to the desired brushing technique.

Electronic game-like systems using electronic toothbrushes have also been developed to encourage children to brush properly by performing a game operation through brush movement. For example, the child may advance a sprite, such as an animated image of a mouse, through a maze to the location of a prize such as an image of cheese, by moving the brush through a predefined set of movements for predefined intervals. While these systems provide an effective reward for children to encourage them to complete a desired brushing routine, they presume that the children know how to hold and move the toothbrush as a prerequisite to using the game effectively. These systems fail to provide any instruction concerning the desired brushing technique or feedback concerning brush positioning, orientation, motion or pressure with respect to the desired brushing action. As a result, these systems only monitor general toothbrush movement without providing any instruction, assessment, or feedback based on performance of the desired brushing routine.

Ineffective tooth brushing by children can have the undesirable consequences of increased tooth decay, periodontal disease, bad breath, uncomfortable or even traumatic dental procedures, potential long term tooth and gum damage, and increased dental health costs. There is, therefore, a continuing need for more effective tooth brush training systems for children.

### SUMMARY

The needs described above are met by a multimedia toothbrush training system and, more particularly, by a toothbrush training system for children utilizing an instrumented toothbrush with some combination of motion, orientation, position and pressure sensors, along with feedback elements, interacting with a dynamic audio-visual instructional program providing guidance and feedback on proper brushing procedures. The system provides instruction on tooth brushing technique in combination with monitoring and corrective feedback based on that performance and deviation from the desired brushing technique within the context of an audio-visual game environment. Toothbrush performance data, which may include position, orientation, acceleration (inertia) and pressure, is broadcast by the toothbrush and picked up by a receiver associated with the audio-visual system controller, which monitors the tooth brushing technique performed by the user while providing instructions and feedback in the context of the dynamic instructional audio-visual presentation.

The instructional program uses an animated character to illustrate the desired toothbrush positioning and movement for cleaning specific tooth surfaces. The content and progress of the audio-visual presentation may be dynamically altered based on data received from the electronic toothbrush to adjust the presentation in response to a comparison of the instructional information and the actual tooth brushing movement performed by the user. For example, the instructional audio-visual program may include presentation of an animated depiction of the precise toothbrush position and desired movement while a song provides brushing instructions with the musical beat corresponding to the tempo of the desired brush movement. Toothbrush sensors may include a local position sensor, a geoposition sensor, an inertial motion sensor that conveys orientation and acceleration, and a pressure sensor. Several types of feedback elements may be employed, such as toothbrush vibrations, tones, audio announcements, and visual changes to provide feedback during the brushing process. Feedback may respond to the position of the toothbrush, the pitch, yaw or roll of the toothbrush, the rate of movement, pressure applied to the teeth, the duration of movement, and so forth.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE FIGURES

The numerous advantages of the invention may be better understood with reference to the accompanying figures in which:

FIG. 1 is a conceptual illustration of the toothbrush training system being used by a child.

FIG. 2 is a conceptual illustration of an instrumented toothbrush for use with the toothbrush training system.

FIGS. 3A-B are perspective views of alternative toothbrush adapters for a multi-purpose wireless handle unit.

FIG. 4 is a tooth diagram illustrating brushing surfaces for an example of the toothbrush training routine.

FIG. 5 is a functional block diagram of the toothbrush training system.

FIGS. 6A-B are depictions of the front and rear sides of an animated character for an example audio-visual presentation of the toothbrush training system.

FIG. 7 is a conceptual illustration of haptic feedback in the toothbrush training system.

FIG. 8 is a conceptual illustration of a first type of toothbrush position and motion illustration by the audio-visual presentation of the toothbrush training system.

FIG. 9 is a conceptual illustration of a second type of toothbrush position and motion illustration by the audio-visual presentation of the toothbrush training system.

FIG. 10 is a conceptual illustration of a third type of toothbrush position and motion illustration by the audio-visual presentation of the toothbrush training system.

FIG. 11 is a conceptual illustration of a first tooth brushing instruction set to music by the audio-visual presentation of the toothbrush training system.

FIG. 12 is a conceptual illustration of a second tooth brushing instruction set to music by the audio-visual presentation of the toothbrush training system.

FIG. 13 is a conceptual illustration of a first type of corrective feedback by the audio-visual presentation of the toothbrush training system.

FIG. 14 is a conceptual illustration of a second type of corrective feedback by the audio-visual presentation of the toothbrush training system.

FIG. 15 is a conceptual illustration of a third type of corrective feedback by the audio-visual presentation of the toothbrush training system.

FIGS. 16A-B are conceptual illustrations of a first type of positive feedback by the audio-visual presentation of the toothbrush training system.

FIGS. 17A-C are conceptual illustrations of a progressive positive feedback by the audio-visual presentation of the toothbrush training system.

### DETAILED DESCRIPTION OF ILLUSTRATIVE EMBODIMENTS

The invention may be embodied in a toothbrush training system for children providing instruction on tooth brushing technique in combination with monitoring and corrective feedback based on that technique in the context of an audio-visual game environment. The system utilizes a toothbrush with some combination of sensors measuring position, acceleration, torque and pressure sensors, along with optional feedback elements interacting with a dynamic audio-visual instructional program providing guidance, assessment and feedback on proper brushing procedures. The instructional program includes software that runs on a multimedia controller, which interacts with and controls the instrumented toothbrush, an electronic display, and an audio system. For example, the toothbrush training system may be implemented as an application for a host Wii® inertial-motion game system, with either an instrumented toothbrush or a toothbrush end effector that plugs into the inertial-motion human input device (game handle) provided with the host game system that serves as the handle for the toothbrush.

The toothbrush training system includes a number of innovative features not realized by prior toothbrush training systems or game systems, highlighted by but not limited to those summarized below. The instructional audio-visual presentation typically includes an animated character that visually demonstrates how the child is to position and move the toothbrush as part of the training system. In the illustrative example shown in the appended figures, a character referred to as “Mr. Molar” has a separating head with exaggerated teeth with an upper head with upper teeth detaching from the lower head with lower teeth. Mr. Molar is displayed along with an image of the toothbrush illustrating the desired position, desired orientation and desired motion of the toothbrush for the desired interval. The animation moves through the desired brushing technique in sequence for a number of brushing surfaces.

The training system monitors the user's brushing motion, compares the actual motion to a desired motion profile, and provides feedback to help guide the user to complete the desired brushing action. Negative feedback, such as beeps and vibrations, may indicate desired corrections when the toothbrush is positioned or moved improperly. In addition to a cessation of negative feedback, positive feedback, such as a visual presentation of gunk removal on Mr. Molar's teeth and audio-visual encouragement, may indicate successful performance of the desired brushing technique to guide the user through the desired brushing routine.

The audio-visual presentation preferably includes music accompanying the visual animation, where the lyrics announce the brushing instructions and the beat corresponds to the desired brushing tempo. Children are generally familiar with, understand and are particularly well motivated by this type of combined instruction and feedback set to music and employing videogame conventions. Selectable brushing routines may have varying levels of granularity, for example a particular technique may include 24 brushing surfaces separately addressed in the instructional animation and associated song. Each brushing surface and motion may be given a memorable name within a child's vocabulary with the brushing technique set to music helping the children understand the instructions. Just to give a couple of examples, the lyrics may include, “shine the biters, sweep, sweep”; “clean the chewers, sweep, sweep”; “brush the crunchers, sweep sweep” and so forth.

In addition to tones and vibration, interruptions of the progress of the animation and verbal instruction may be announced to encourage specific technique corrections. A few illustrative examples, which may accompanying video demonstration, include “hold the toothbrush more level”; “not so hard”; “slow down a little and follow the music”; and “tilt the toothbrush a little more.” Positive feedback may include, “that's it!” and “now you've got it.” An animated celebration showing an elated Mr. Molar with clean, shiny teeth, triumphant music, congratulatory announcements, and other forms of traditional game rewards may follow successful completion of the desired brushing routine. These rewards may include points, awards and in-game prizes, such as extra play levels, or special toothbrushes. Again, children are generally familiar with, understand and are particularly well motivated by this type of game-like reward and adulation. The child's success and daily progress are readily visible to parents, care-givers and to dental health professionals both on-screen and online. These adults may introduce their own systems of incentives.

While a specific set of toothbrush sensors, a specific animated character, and a specific tooth brushing routine with an illustrative set of brushing surfaces are shown in the figures and described below, it should be understood that these elements constitute a particular embodiment provided to illustrate the features and objectives of the invention. Of course, different sets of sensors, characters, brushing routines, music, and other features may be employed to implement the functionality of the invention. In addition, different elements and combinations of the novel features may be employed to implement different aspects and versions of the invention. Therefore, it will be appreciated that the specific embodiments described below are provided only as specific examples designed to illustrate the inventive concepts.

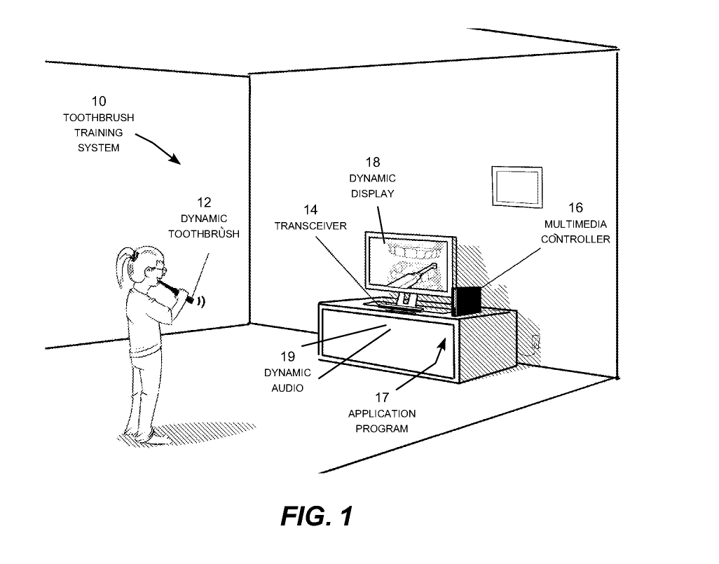

Turning now to the figures, FIG. 1 is a conceptual illustration of the toothbrush training system 10 being used by a child. The system includes an instrumented toothbrush 12 with sensors and optional feedback elements along with a transmitter 27 that communicate a data signal reflecting data acquired by the sensors. Note that in different embodiments, feedback may be provided entirely through the audio-visual system, entirely through toothbrush resident feedback elements, or with a combination of these devices. The transmitter 27 communicates with a transceiver 14 connected to a multimedia controller 16 associated with a toothbrush trainer application program 17 running on the controller 16, which implements the dynamic audio-visual instructional and feedback program. The controller 16 directs feedback provided through the toothbrush resident feedback elements as well as a dynamic video presentation 18 shown on a monitor and a dynamic audio presentation 19 played through a speaker system. The dynamic audio-visual presentation, aided by feedback provided through the toothbrush if desired, teaches the user how to position and move the toothbrush to perform a desired tooth brushing technique.

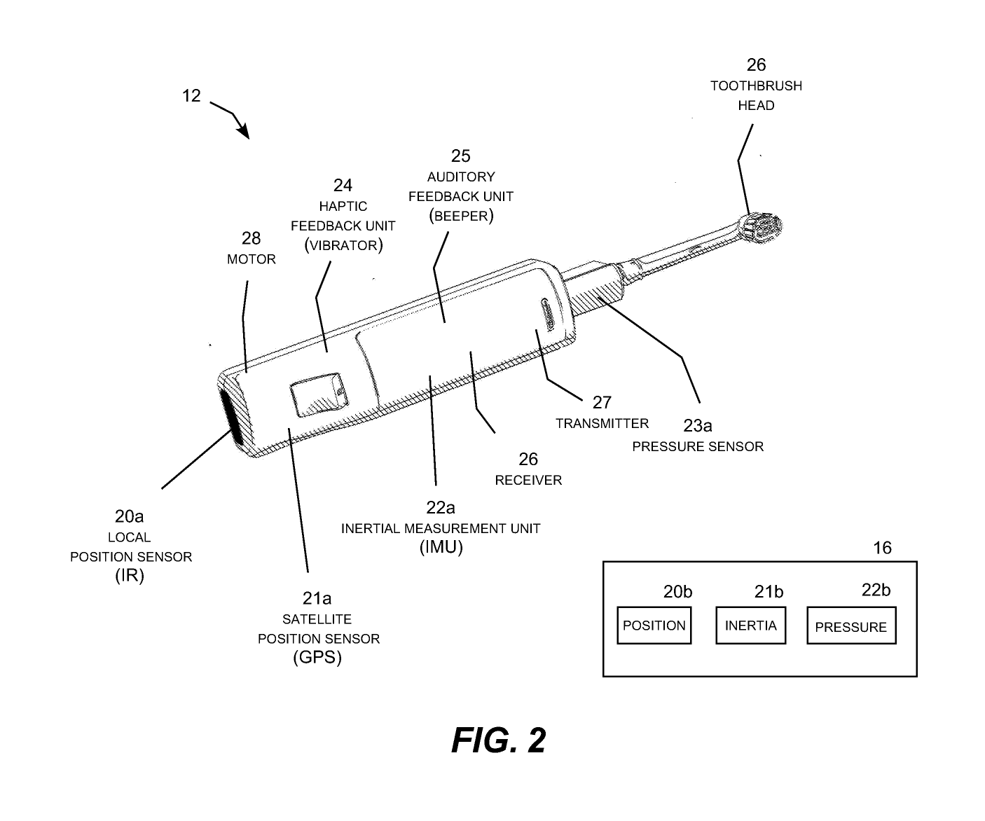

FIG. 2 is a conceptual illustration of the electronic toothbrush 12 for use with the toothbrush training system. To implement the invention, the toothbrush 12 includes a local position sensor (typically a camera or other suitable type of optical sensor) 20a that communicates with a position tracking unit 20b on the controller 16 allowing the controller to monitor the position of the toothbrush. For example, the position sensor on the toothbrush may include a camera that looks at a pair of IR emitters (LEDs) mounted near the controller at fixed distance apart, which uses geometry to calculate the viewing position of the toothbrush relative to these reference points. Alternatively or additionally, the toothbrush 12 may include a geoposition sensor (typically a global positioning system [GPS]) 21a that communicates with a position tracking unit 21b on the controller 16 allowing the controller to monitor the position of the toothbrush. The GPS system preferably includes a second GPS location unit providing local differential correction allowing the controller to accurately monitor the relative position of the toothbrush with respect to the controller despite signal drift that might occur in the satellite position signals. It should be appreciated, however, that a functional system does not require position information. As it generally be presumed that a child trying to brush can generally position the toothbrush next to their teeth, the orientation, motion and pressure may be monitored parameters to help the child learn the specific orientation, motion and pressure desired for an effective brushing technique.

The toothbrush 12 may also (but does not necessarily) contain power cleaning features such as a spin, sonic or other actator. For example, the instrumented toothbrush may include the usual elements of an electric toothbrush, generally including a toothbrush cleaning head 26 (typically a spin brush or sonic head) along with a motor 28 that operates the toothbrush head and toothbrush resident feedback elements, such as a haptic feedback unit 24 (typically a vibrator) and an auditory feedback unit 25 (typically a beeper or tone generator).

The toothbrush 12 may also include an inertial measurement unit (IMU) 22a that communicates with an inertia tracking unit 22b on the controller 16 allowing the controller to monitor the orientation and motion of the toothbrush. Typically, the IMU includes three accelerometers and three gyroscopes measuring orientation and movement in three coordinates, which may be located on a single electronic chip. The toothbrush 12 may further includes a pressure sensor (typically a Hall-effect sensor) 23a that communicates with a pressure tracking unit 23b on the controller 16 allowing the controller to monitor the pressure applied by the toothbrush to the teeth during the brushing motion.

FIG. 2 is a conceptual illustration of the instrumented toothbrush 12 for use with the toothbrush training system. To implement the invention, the toothbrush 12 includes an inertial measurement unit (IMU) 22a that communicates with an inertia tracking unit 22b on the controller 16 allowing the controller to monitor the orientation and motion of the toothbrush. Typically, the IMU includes three accelerometers and three gyroscopes measuring both linear acceleration and angular acceleration in three dimensions, all of which may be located on a single electronic part. The toothbrush 12 may further include a pressure sensor (typically a Hall-effect sensor) 23a that communicates with a pressure tracking unit 23b on the controller 16 allowing the controller to monitor the pressure applied by the toothbrush to the teeth during the brushing motion.

The toothbrush 12 also may include a local relative position sensor (typically an infrared [IR] camera) 20a that tracks reference points in the room and communicates with a position tracking unit 20b on the controller 16 allowing the controller to monitor the position of the toothbrush. The toothbrush 12 may alternatively, or additionally include a geoposition sensor [GPS] 21a that communicates with the position tracking unit 20b on the controller 16 allowing the controller to monitor the position of the toothbrush. Alternatively, the position tracking unit 20b on the controller may include its own camera to view the position of both the toothbrush and the child's head, requiring no sensor on the brush. Yet another alternative is that the position tracking unit 20b may estimate the brush position based on inertial data or other heuristics.

The toothbrush 12 may also include resident feedback elements, such as a haptic feedback unit (typically a vibrator) 24 and an auditory feedback unit 25 such as a small speaker, beeper or tone generator. The toothbrush 12 includes a tooth-cleaning head (typically an array of bristles) which may or may not be actuated by elements of a power toothbrush such as a spin or sonic actuator.

Unlike prior systems, this combination of sensors provides a highly accurate toothbrush position, orientation, motion and pressure monitoring data signal. In particular, it allows the orientation and motion of the toothbrush to be determined with respect to three spatial axes. For example, the orientation of the toothbrush may be monitored in pitch, yaw and roll coordinates, while the motion of the toothbrush may be monitored for lateral movement in Cartesian space as well as rotation (sweeping action) around the longitudinal axis of the brush. Precise monitoring of the brushing orientation and action facilitates detailed instruction on the desired brushing technique as well as accurate assessment of the action performed by the child, along with both corrective and positive feedback.

In addition, no prior toothbrush training system has implemented a combination of tooth brushing instruction, assessment and feedback. The result is a very powerful training system, particularly when combined with the other features of the system including a game-based learning environment, multi-media feedback, effective video instruction, a mnemonic musical presentation in which the lyrics provide the instruction and the beat matches the desired brushing tempo and the musical structure enforces the stroke count, and game-based rewards upon proper completion of the desired brushing routine.

The toothbrush may be a unitary device or it may include a handle, such as a multi-purpose human input device (game controller used, for this application, as the instrumented toothbrush handle), with a separate toothbrush adapter that attaches to the handle when the user wants to use the multi-purpose game as a toothbrush trainer. Embodiments that use a toothbrush adapter connected to multi-purpose wireless handle unit may utilize local IR positioning typically provided as a feature of the multi-purpose wireless handle unit, while a complete toothbrush unit.

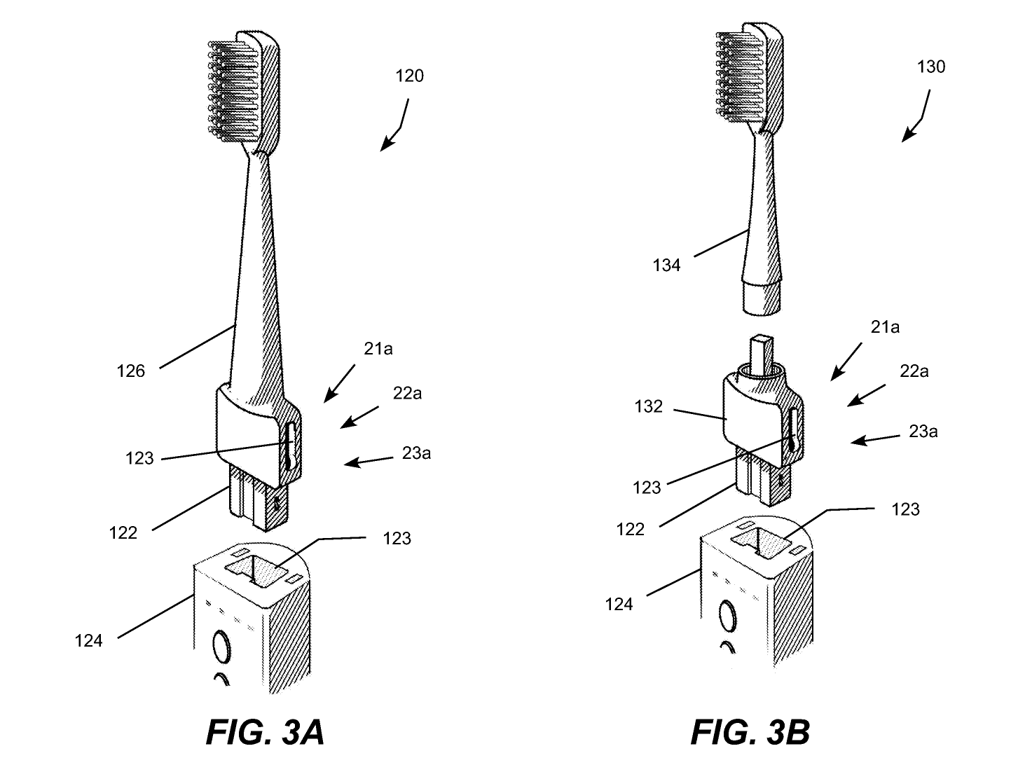

FIG. 3A-B are perspective views of alternative toothbrush adapters for a multi-purpose wireless handle unit. FIG. 3A shows a toothbrush adapter 120 adapter that includes a plug 122 configured to be received in a socket 122 on a multi-purpose wireless handle unit 124, such as the wireless input unit provided with the Wii® game system. The plug 122 provides mechanical support as well as an optional electric power to the adapter, which may augment the handle unit with auxiliary sensors for geoposition 21a, high-resolution inertia 22a, and pressure 23a. The adapter may also include a latch release 123 to release a catch that secures the adapter 120 to the wireless handle unit 124 once the plug 122 is received within the socket 123.

FIG. 3B shows a variation for the toothbrush adapter, in which the adapter 130 is base 132 containing the plug 122 and the latch release 123, along with a fitting for a removable bristle head 134 that is supported by, and may be removed from, the base 132. This allows the bristle fitting 134 to be fitted for the comfort of the individual user and to be supplied by third-party sources, and also to be replaced when the bristles wear out without the need to replace the adaptor 132. In some embodiments, the base 132 may include auxiliary electronic sensors 21a, 22a, 23a.

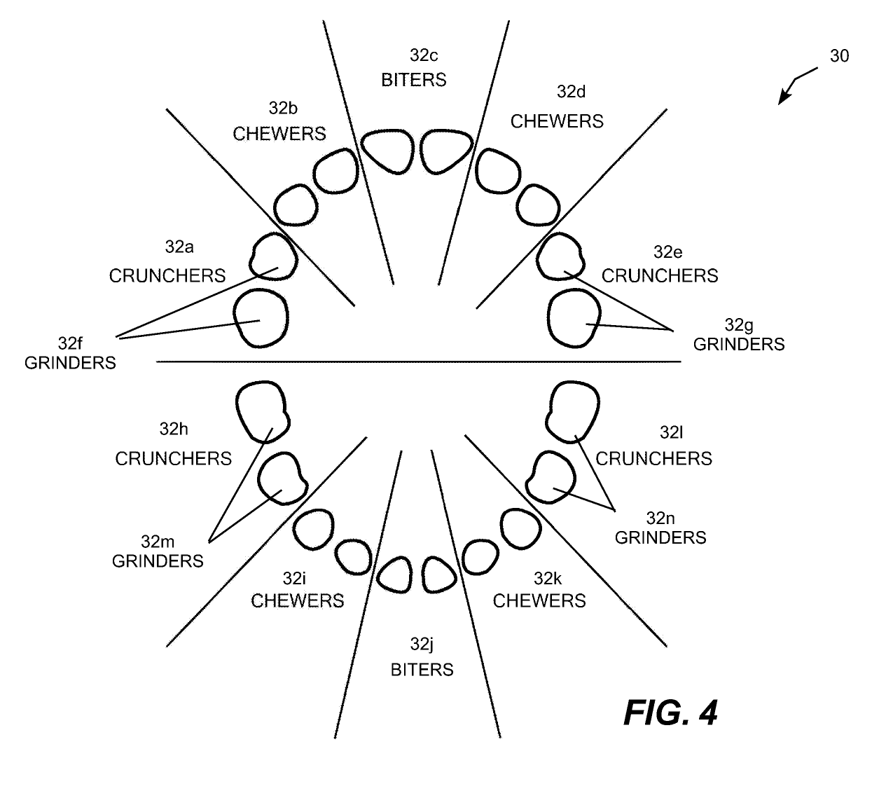

FIG. 4 is a tooth diagram 30 illustrating brushing surfaces for an example of the toothbrush training routine. Although any desired tooth brushing routine may be utilized, the high precision of toothbrush monitoring along with an entertaining multi-media presentation to keep the child's attention, allows for enhanced granularity in the brushing routine reflected in multiple brushing surfaces and brushing strokes. For example, FIG. 4 shows an example in which the tooth brushing routine is divided into 24 brushing surfaces. For each of both the upper and lower jaw, these include lingual and buccal surfaces for each of five tooth groups along with occlusal surfaces for the right and left molar groups. Each brushing surface is given a clear, memorable name using a child's vocabulary. This name is used in a musical presentation of the desired brushing routine (e.g., biters, chewers, crunchers, grinders). This allows for kid-friendly lyrics to be developed, such as “sweep the biters,” “shine the biters,” “scrub the chewers,” “sweep the chewers,” and so forth. These lyrics are set to music having a beat matching the tempo of the desired brushing strokes. The musical structure counts off the number of strokes that the child is expected to perform on each brushing surface. The combination of lyrics, music and tempo, as augmented by the audio-visual presentation and feedback, provides full instruction for the progression through the mouth, attention to each tooth surface, proper execution of each stroke and the tempo and repetition of brush strokes.

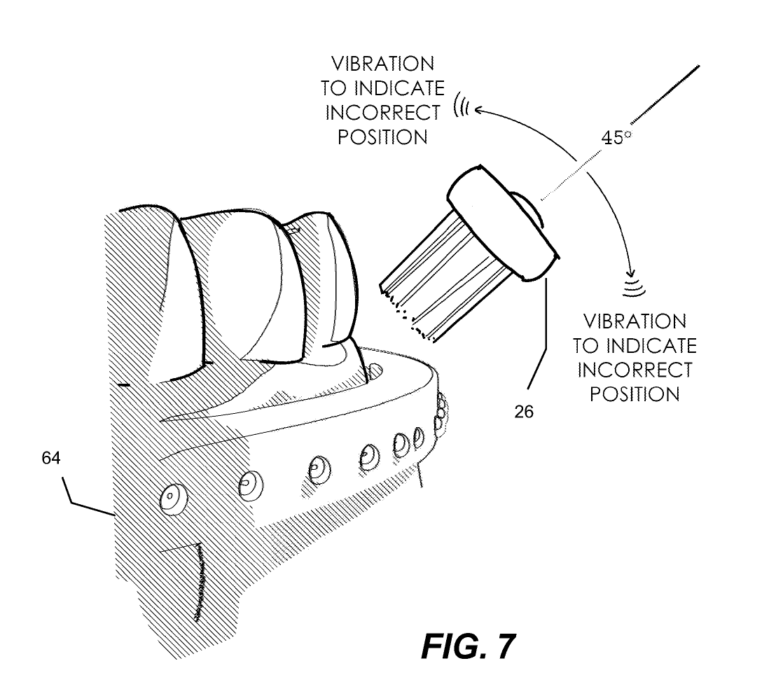

It should be further appreciated that each brushing surface has a corresponding position and three-dimensional orientation for the toothbrush as well as a desired angle between the brush head (see FIG. 7) and the brushing surface, which might be thought of as the rotational “angle of attack.” All of these aspects of the desired brushing action are illustrated by Mr. Molar and may be the subject of feedback provided by the system.

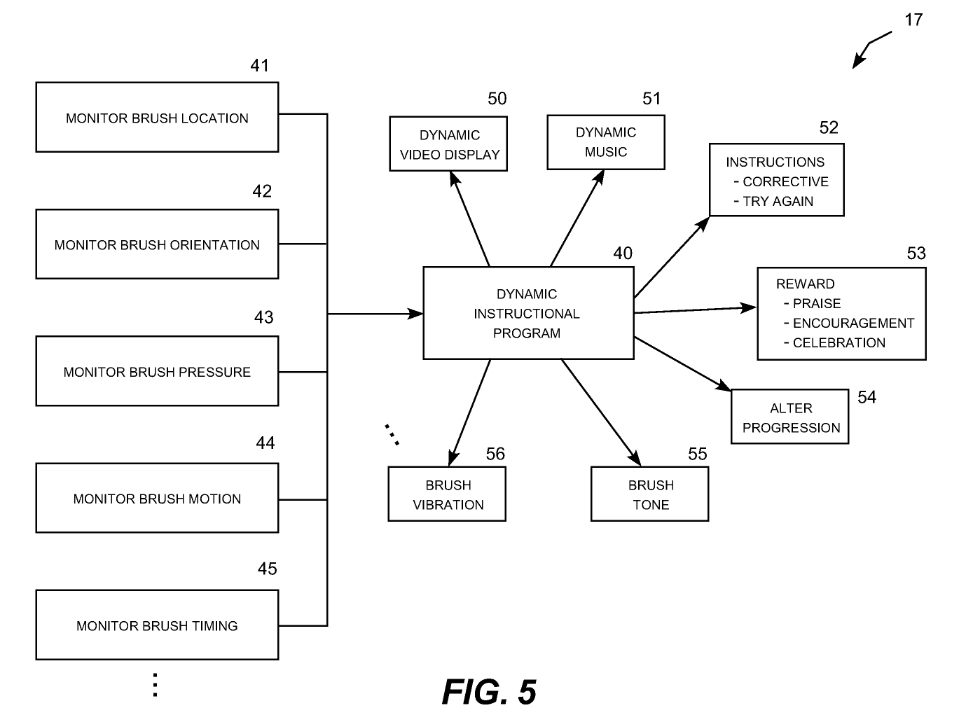

FIG. 5 is a functional block diagram of the toothbrush training system 10 illustrating the functionality performed by the toothbrush trainer application program 17 running on the controller 16 to implement the dynamic audio-visual instructional and feedback program. The application program 17 implements a dynamic instructional program 40 that plays an instructional audio-visual presentation instructing the user on a desired tooth brushing routine, monitors the tooth brushing technique implemented by the user, and provides feedback which may include interrupting or altering the audio-visual presentation to provide corrective feedback as well as positive feedback as needed to enhance the efficacy of the training. For example, if initial feedback such as visual cues or haptic signals do not result in correction of a detected deviation from the desired routine, the dynamic instructional program may interrupt the presentation and verbally (potentially with visual demonstration) instruct the user to “hold the toothbrush level,” or “slow down, you are brushing too fast,” or “don't press so hard,” and so forth. A proper correction may be responded to with “that's it!” or “way to go, you have it now,” or another encouragement.

To implement the dynamic training protocol, the instructional program 40 implements brush location monitoring functionality 41, brush orientation monitoring functionality 42, brush pressure monitoring functionality 43, brush motion monitoring functionality 44, brush timing monitoring functionality 45, and may be augmented to monitor additional features of the tooth brushing technique (e.g., tooth paste detection) if desired. The desired tooth brushing routine including specific toothbrush position, orientation and motion for desired intervals is provided through a dynamic video display 50, and a dynamic musical presentation 51 explaining, demonstrating and setting the tempo for the desired action. The audio-visual presentation may be dynamically altered with instructive corrections 52 (e.g., corrective instructions, instructions to try again, etc.), positive feedback 53 (e.g., praise, encouragement, celebration, etc.), and alterations to the progression of the routine 54 (e.g., start over, repeat an action, terminate in response to lack of motion, etc.), and may be augmented to implement additional feedback techniques (e.g., flashing lights, voice-over commands, another “pop-up” animated character providing extra instruction, and so forth) if desired.

In addition to feedback provided by the audio-visual presentation described above, the instructional program 40 may also implement feedback through the brush itself utilizing the toothbrush resident auditory 55 and haptic 56 feedback features. This type of feedback can increase in tone, intensity or frequency in response to the amount of deviation to continually assist the user in finding the correct brushing technique during the course of the tooth brushing session. The combination of audio-visual and toothbrush-resident feedback techniques has been found to be a particularly useful training technique. Those skilled in the art will be able to develop additional instructive techniques once the fundamental elements of the invention are understood.

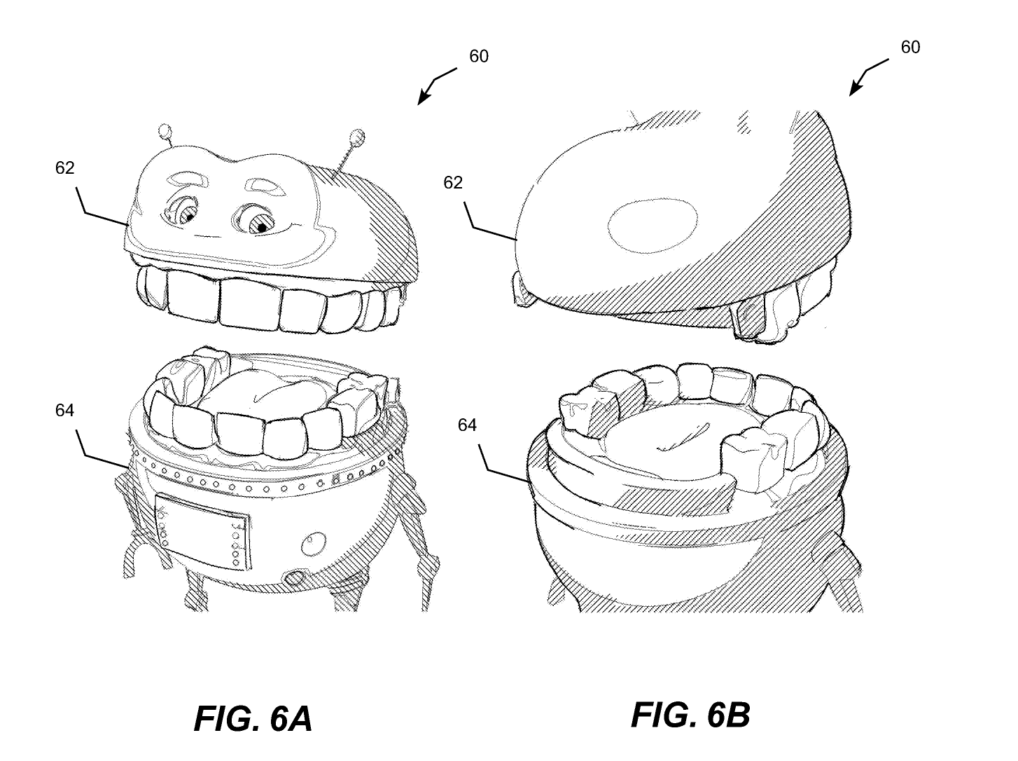

Those skilled in the art will be able to develop a variety of brushing routines, characters, instructions, music, and so forth. To provide one example found to be well received by American children, FIGS. 6A-B show the front and rear sides of a character 60 referred to as “Mr. Molar” developed for the system 10. While many different characters may be used, “Mr. Molar” has a number of characteristics well suited to toothbrush training. This character has highly exaggerated teeth and separating top and bottom head portions, each with one set of the upper and lower teeth (i.e., a top head portion with the upper teeth detachable from a lower head portion with the lower teeth). Mr. Molar can also be rotated to show him from the front as in FIG. 6A, the rear as in FIG. 6B, or from any other desired point of view.

An innovative design feature of “Mr. Molar” is the detached upper head, which permits the system to clearly show the brushing of inner (lingual) tooth surfaces while the virtual camera is positioned outside the character itself. That is, the character has an upper head detachable from a lower head permitting the audio-visual program to display the lingual tooth surfaces from a point of view outside of the character's mouth. The image can also be zoomed and animated in any desired manner. This conveniently allows an electronic depiction of the toothbrush to illustrate specific toothbrush position, orientation, angle of attack, and motion for specific brushing strokes shown with respect to Mr. Molar's teeth. Separate groups of teeth defining specific brushing surfaces (for example where each brushing surface includes portions of multiple teeth as shown in FIG. 4) may also be highlighted to indicate the specific brushing surfaces as they are addressed by the instruction program.

FIG. 7 is a conceptual illustration of haptic feedback in the toothbrush training system. In this example, a desired 45° angle of attack between the toothbrush head 26 and the brushing surface 64 is shown. A close up of this view may be displayed to the users to teach them the correct way to orient the toothbrush cleaning head with respect to the brushing surface. Similar views may be used to illustrate the movement of the cleaning head with respect to brushing surface, the overall toothbrush position (e.g., brush adjacent to the desired brushing surface), and the orientation (e.g. hold the brush level) for each brushing surface and stroke.

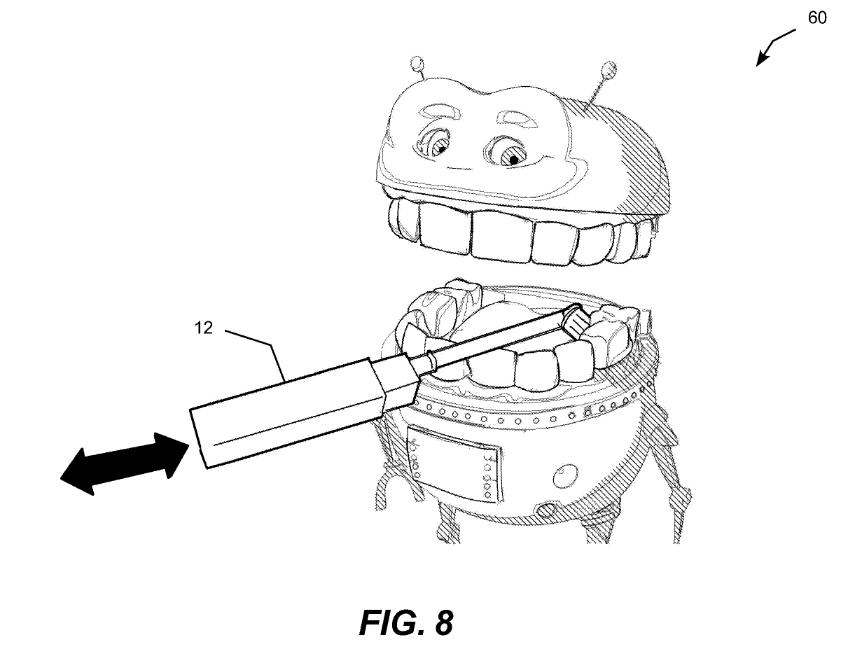

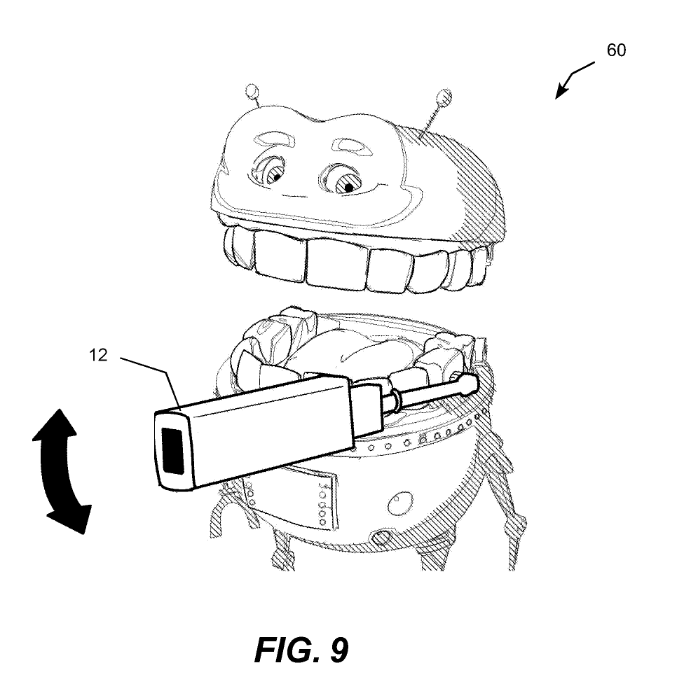

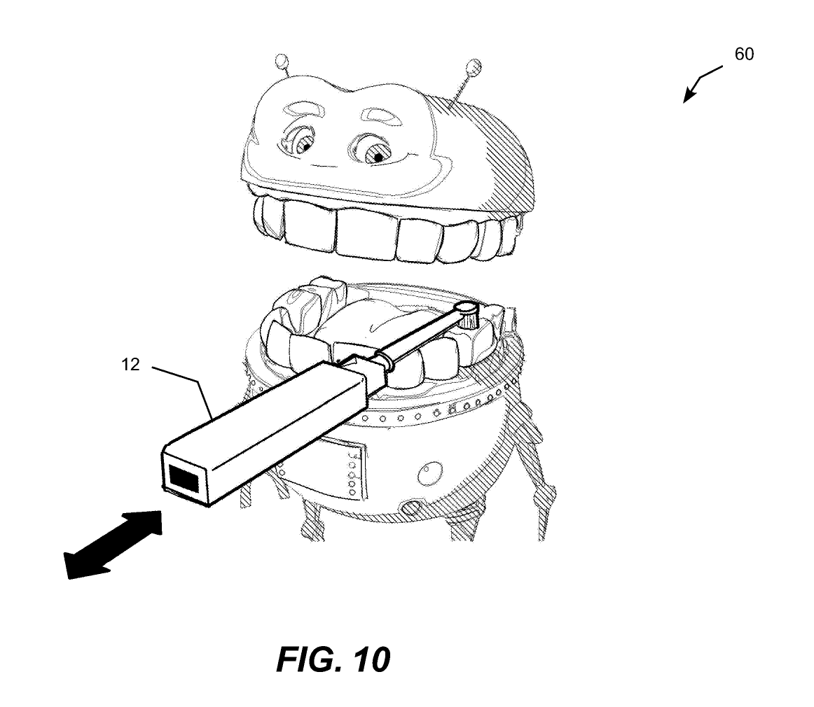

While many brushing surfaces and strokes may be employed, a number of specific examples will be provided to illustrate basic types of instruction enabled by the system. Like the brushing surfaces, the brushing motions may be given names allowing them to be recognizably incorporated into verbal and musical instructions. FIG. 8 shows the Mr. Molar character 60 demonstrating a “brush” motion. Note that the image shows the desired brushing surface, and the desired motion, along with the toothbrush located in the desired position, orientation and angle of attack for the particular brushing stroke. The video may also show a diagrammatic arrow in addition to the motion of the brush. FIG. 9 shows another typical motion, with this view illustrating a “sweep” motion. FIG. 10 shows a “scrub” motion.

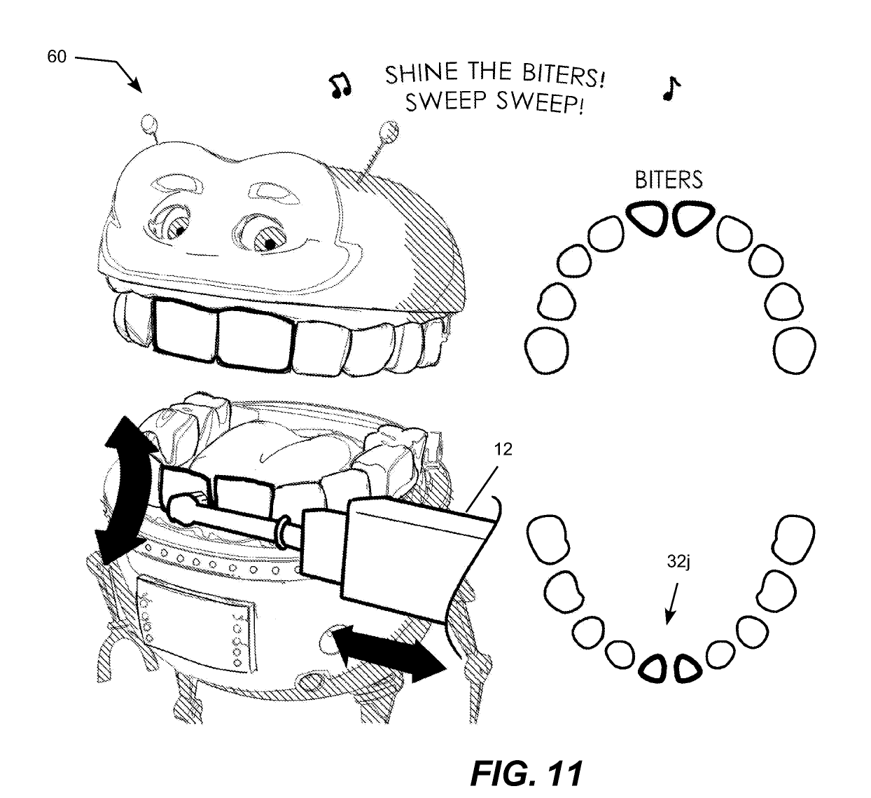

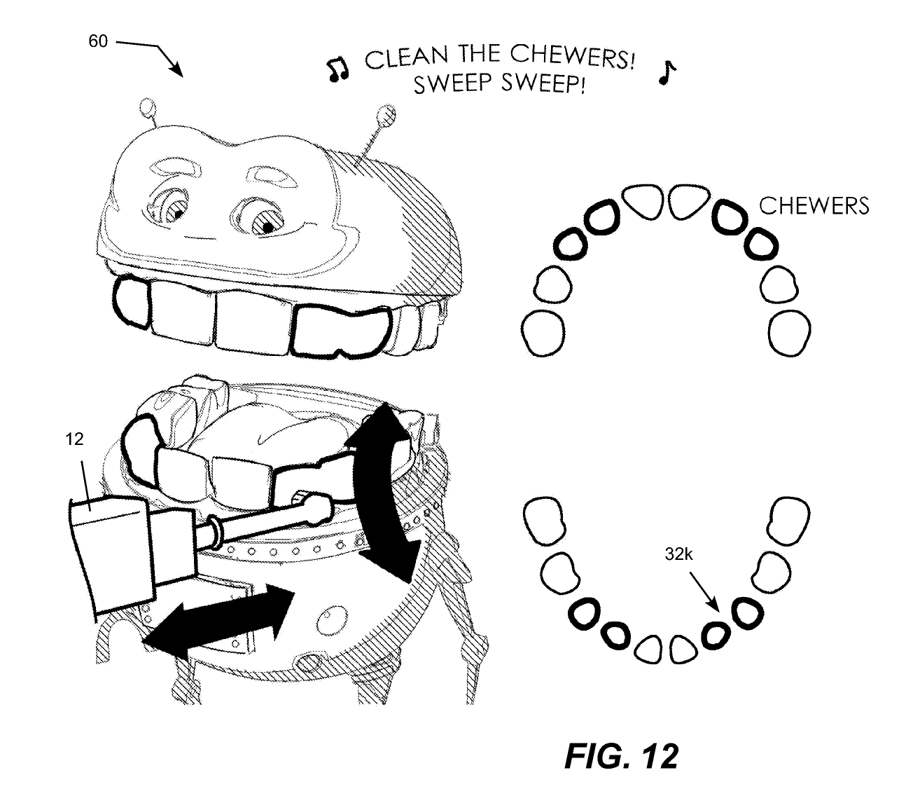

The instructional program 40 puts all of these elements together in the context of a multi-media presentation in which the instructions are embodied in a song where the lyrics convey the verbal instructions for progression through the mouth and execution of each stroke and the music conveys the tempo and number of the brush strokes. The song corresponds to a progression of tooth brushing surfaces going around the mouth and measures out a desired stroke count for each tooth brushing surface. To provide one example, FIG. 11 shows the instruction for an illustrative motion described by the music, “shine the biters, sweep sweep” which is played for the duration of that particular brushing action. The arrows in the figure illustrate the brushing motions that are depicted duration the brushing action. This shows the user exactly what the user is expected to do while the lyrics and beat of the music reinforce this instruction. FIG. 12 similarly illustrates another stroke, in this case, “clean the chewers, sweep sweep.”

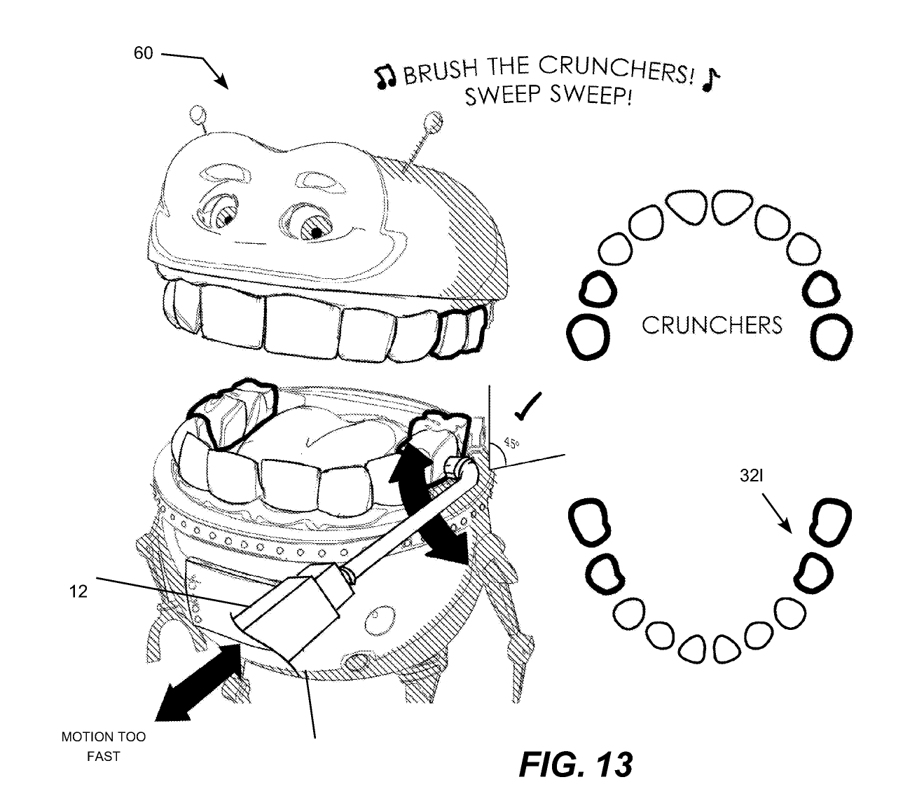

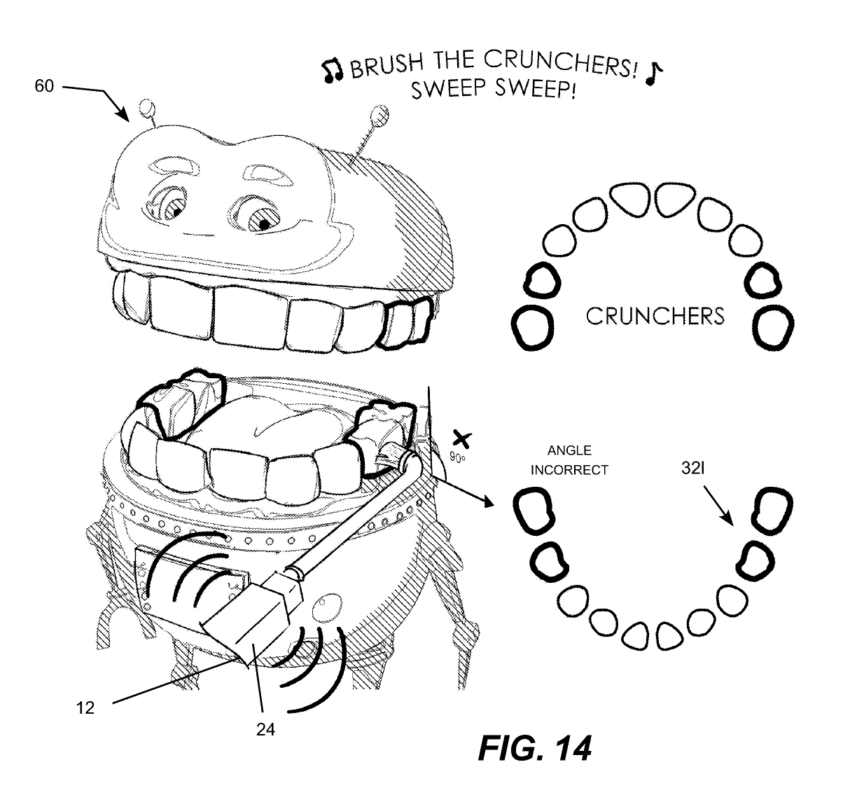

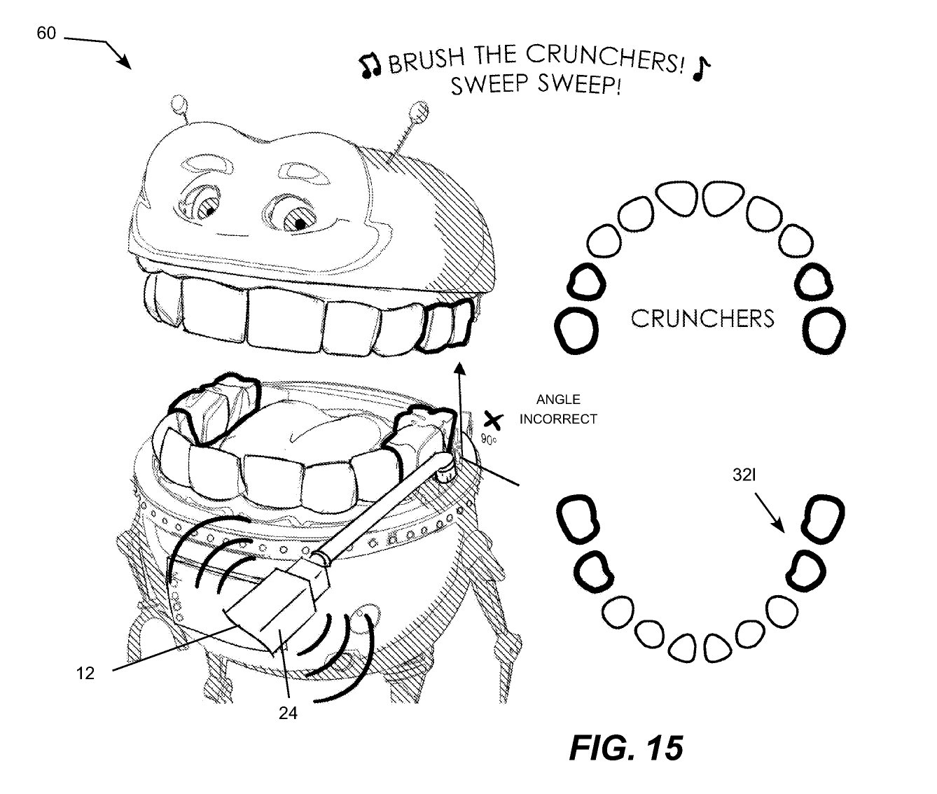

FIG. 13 illustrates another stroke, “brush the crunchers, sweep sweep” further illustrating certain types of feedback that may be provided. For example, the brush may play a tone if the stroke is too fast or slow, which may increase in volume or frequency in response to increased deviation from the desired action. FIGS. 14 and 15 illustrate brush vibration feedback when the angle of attack is incorrect. Haptic feedback has been found to be useful for providing feedback for deviation from the desired angle of attack. The amplitude of the vibration may increase to indicate increasing deviation. Auditory feedback may be used to signal performance shortcomings. Many other feedback paradigms, including those incorporating elements of the audio-visual program and the toothbrush resident feedback elements may be developed with different routines suited to different ages, demographics, and training levels.

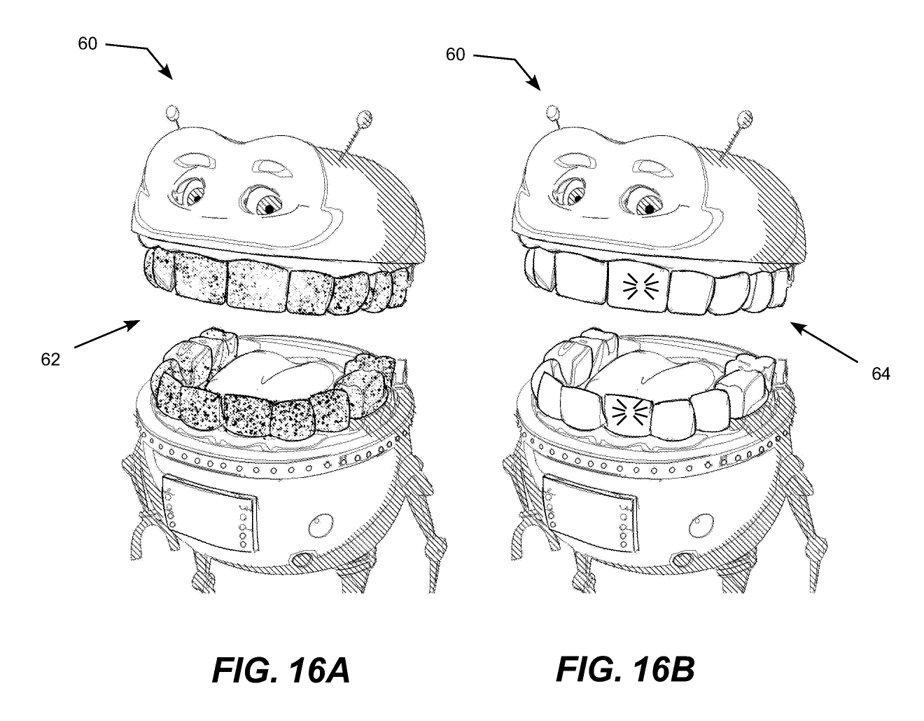

FIGS. 16A-B show another type of feedback that has been found to be particularly effective for children, in which Mr. Molar's teeth bear a heavy level of green debris (“gunk”), as shown in FIG. 16A, that is removed through successful completion of the desired brushing routine to produce the sparkling clean teeth shown in FIG. 16B. The sparkling feature may be much enhanced by video to encourage the children to brush properly until their teeth are nice and clean like Mr. Molar's. Many other audio-visual elements may encourage and reward successful completion of the brushing routine, such as triumphant music and special video effects. The successful brusher may be rewarded with the acquisition of points, medals, badges and other symbols of achievement, which are recorded locally or online for parental and caregiver review and further reward as desired. Success may be accompanied by the “unlocking” of restricted game features such as advanced levels, desirable toothbrushes, and new music or avatars.

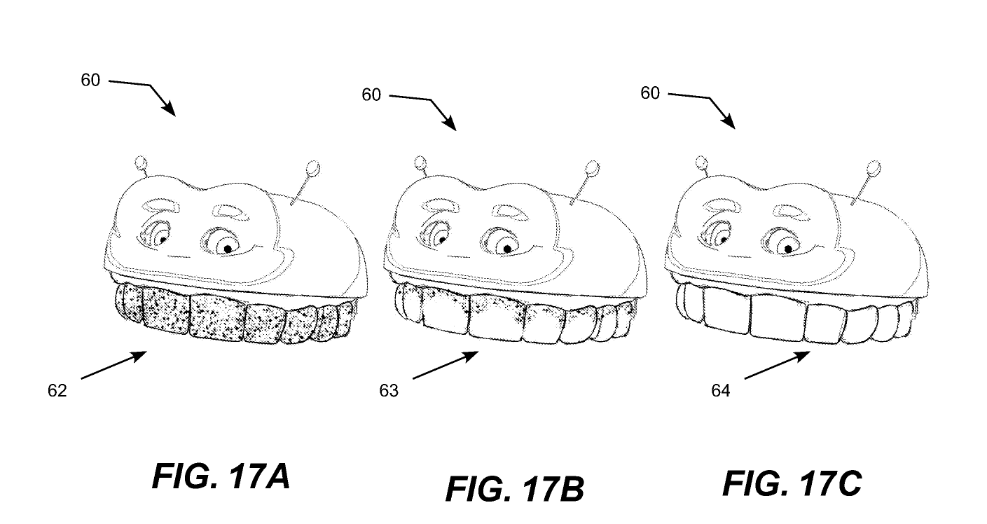

Gunk removal may also be depicted as a progression, as shown in FIGS. 17A-C, and may be shown for different brushing surfaces depending on how well the user completed the desired cleaning operation for different brushing surfaces. The end result of the brushing routine, as illustrated by gunk removal levels on various brushing surfaces, may be displayed to the user in a post-routine review that may be stored for later review. The instructive program may highlight for the user the specific areas where the desired brushing routine was not completed properly and provide the user with the option of returning to go over those areas again. The instructive program may also store the date-stamped end result of each tooth brushing session, for example as depicted by iconic gunk removal images, or a full motion video clip, or as numeric performance statistics. These data can be presented in a variety of formats for review by a human brushing mentor (such as parent or oral health professional). These mentors can review an individual session in detail, or observe a longitudinal time-series to monitor the progress of the child's skill acquisition. Online systems allow these performance data to be shared outside the home, in compliance with relevant privacy regulations.

It should also be appreciated that different characters, feedback paradigms, songs, rewards and other elements may be tailored for children of different ages, training levels, and other demographic factors. As another option, these elements may be selected (mix and match) separately for each user to provide an individualized and adjustable routine for each user. As another option, Mr. Molar may be replaced by a customized avatar selected by and potentially resembling the specific user. Many other potential features and variations will become apparent to those skilled in the art one they become familiar with the basic element of the invention.

The present invention may be implemented as a software application running on a general purpose computer including an app for a portable computing device, a software application running on a server system providing access to a number of client systems over a network, or as a dedicated computing system. As such, embodiments of the invention may consist (but not required to consist) of adapting or reconfiguring presently existing equipment. Alternatively, original equipment may be provided embodying the invention.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. The invention is defined by the following claims, which should be construed to encompass one or more structures or function of one or more of the illustrative embodiments described above, equivalents and obvious variations.

The invention claimed is:

1. A toothbrush training system, comprising:
an instrumented toothbrush comprising one or more sensors operative for monitoring tooth brushing action and one or more transmitters operative for communicating a data signal reflecting data acquired by the sensors;
a controller operative for receiving the data signal and driving an audio-visual system to present an instructional tooth brushing program providing instruction for performing a tooth brushing routine and feedback to a user of the toothbrush based on performance qualities determined through analysis of the sensor data.

2. The toothbrush training system of claim 1, wherein the sensors comprise any combination comprising position, orientation, acceleration, torque and pressure sensors.

3. The toothbrush training system of claim 1, wherein the toothbrush further comprises toothbrush resident feedback elements controlled by the controller.

4. The toothbrush training system of claim 3, wherein the toothbrush resident feedback elements comprise a haptic feedback element and/or an audible feedback element.

5. The toothbrush training system of claim 1, wherein the controller is further operative for providing feedback through the audio-visual system.

6. The toothbrush training system of claim 5, wherein the feedback provided through the audio-visual system comprises visual depiction of gunk removal from the teeth of a depicted character.

7. The toothbrush training system of claim 5, wherein the feedback provided through the audio-visual system comprises interruption of the tooth brushing program and announcement of a corrective instruction.

8. The toothbrush training system of claim 1, wherein the instrumented toothbrush further comprises a wireless human input device within a handle unit and toothbrush adapter comprising the cleaning head and a plug configured to be selectively received by the handle.

9. The toothbrush training system of claim 8, wherein the toothbrush adapter further comprises a base comprising the plug and a bristle fitting configured to be selectively received by the base to accommodate replacement of the bristle fitting without replacement of the base.

10. The toothbrush training system of claim 1, wherein the audio-visual program includes a depiction of an animated character with a depiction of a toothbrush with animation illustrating the depicted toothbrush performing a desired tooth brushing action on the teeth of the animated character.

11. The toothbrush training system of claim 10, wherein the character comprises an upper head detachable from a lower head permitting the audio-visual program to display lingual tooth surfaces from a point of view outside of the character's mouth.

12. The toothbrush training system of claim 10, wherein the audio-visual program further includes music comprising a beat corresponding to a tempo of a desired tooth brushing action.

13. The toothbrush training system of claim 12, where the song guides a user through a tooth brushing progression comprising a plurality of tooth brushing surfaces while measuring out a desired stroke count for each tooth brushing surface.

14. The toothbrush training system of claim 13, wherein the audio-visual program further includes music comprising lyrics conveying instructions for the desired tooth brushing action.

15. A computer storage medium storing non-transitory computer instructions operative for causing a toothbrush training system to perform the step of:
presenting an audio-visual program comprising instruction for performing a desired tooth brushing routine;
receiving a data signal comprising sensor data associated with a brushing action of an instrumented toothbrush comprising sensors producing the sensor data;
determining deviation of the brushing action from the desired tooth brushing routine based on analysis of the sensor data; and
activating feedback in response to the determined deviation.

16. The method of claim 15, further comprising the step of displaying a depiction of an animated character with exaggerated teeth and a depiction of a toothbrush with animation illustrating the depicted toothbrush performing a desired tooth brushing action on the exaggerated teeth of the animated character.

17. The method of claim 16, further comprising the step of depicting gunk removal from teeth of an animated character in response to the sensor data.

18. the method of claim 15, further comprising the step of playing music comprising a beat corresponding to a tempo of the desired tooth brushing action and a musical structure that indicates the number of brush strokes at a plurality of brushing surfaces.

19. The method of claim 18, further comprising the step of playing audio lyrics conveying instructions for a desired tooth brushing action.

20. An instrumented toothbrush, comprising:
a toothbrush cleaning head;
a handle connected to the cleaning head;
one or more sensors for generating sensor data indicative of a tooth brushing action of the toothbrush comprising at least motion data and pressure data indicative of pressure applied by the toothbrush cleaning head; and
one or more transmitters for communicating the sensor data to a controller.

21. The instrumented toothbrush of claim 20, further comprising:
one or more toothbrush resident feedback elements; and
one or more receivers for receiving feedback instructions from the controller and activating the toothbrush resident feedback elements in response to the feedback instructions.

22. The toothbrush of claim 20, further comprising:
a handle comprising a motor, one or more toothbrush resident feedback elements, and a socket for receiving an adapter; and
an toothbrush adapter comprising the toothbrush cleaning head, zero or more sensors, and a plug for selectively attaching the toothbrush adapter to the handle.

23. The toothbrush of claim 20, wherein the adapter further comprises:
a base comprising the plug and one or more sensors; and
a bristle fitting for selectively attaching the toothbrush adapter to the handle.
